(19) United States
(12) Patent Application Publication
(10) Pub. No.: US 2015/0149124 A1
(43) Pub. Date: May 28, 2015

(54) AIRCRAFT SYSTEM VERIFICATION

(71) Applicant: The Boeing Company, Chicago, IL (US)

(72) Inventors: Brent L. Hadley, Kent, WA (US); Patrick J. Eames, Newcastle, WA (US); Michael P. Sciarra, Seattle, WA (US); Joseph F. Floyd, University Place, WA (US); Charles Mark Williams, Kirkland, WA (US)

(73) Assignee: The Boeing Company, Chicago, IL (US)

(21) Appl. No.: 14/605,934

(22) Filed: Jan. 26, 2015

Related U.S. Application Data
(63) Continuation-in-part of application No. 12/331,216, filed on Dec. 9, 2008, now Pat. No. 8,949,751.

(51) Int. Cl. G06F 17/50

(52) U.S. Cl. CPC G06F 17/5095
USPC 703/1; 703/8

(57) ABSTRACT

A verification method for an aircraft system comprises retrieving logical design data associated with the system, and physical design data associated with the system; extracting data from a computer model of the system; converting the retrieved logical and physical design data and the extracted data into a common data format; and performing a difference analysis of the logical and physical design data with the extracted data from the model to identify any non-conformances between the logical design data, the computer model and the physical design data.

This is a continuation-in-part of U.S. Ser. No. 12/331,216 filed 9 Dec. 2008, now U.S. Pat. No. 8,949,751.

### BACKGROUND

Aircraft assembly processes and systems present unique challenges in terms of scale, spatial requirements, and the number of human and system interfaces. Engineering analysis and design definitions are scattered across multiple Product Data Managers (PDMs). Computer models might not satisfy all design definitions, and physical designs might not conform to the computer models.

It is important to verify that the design definitions, computer models, and physical design are consistent. Verification may include analyzing and visualizing computer models using physical mockups, prototype construction, and paper engineering requirements and/or drawings. If the various data is generated with differing engineering toolsets, then the analysis and verification of the system is done manually, generally on paper.

The analysis and verification is very labor intensive. Verification is difficult, especially if the various data is scattered. It is made even more difficult by data access restrictions. For instance, the party generating a system design may not have access to data about the system that is subsequently manufactured.

### SUMMARY

According to an embodiment herein, a verification method for an aircraft system comprises retrieving logical design data associated with the system, and physical design data associated with the system; extracting data from a computer model of the system; converting the retrieved logical and physical design data and the extracted data into a common data format; and performing a difference analysis of the logical and physical design data with the extracted data from the model to identify any non-conformances between the logical design data, the computer model and the physical design data.

According to another embodiment herein, an article comprises non-transitory memory. The memory is encoded with data for causing a processor to access physical design data, and logical design data associated with an aircraft system; extract data from at least one computer model of the aircraft system; convert the retrieved logical and physical design data and the extracted data into a common data format; and perform a difference analysis to identify any non-conformances between the retrieved logical design data, the retrieved physical design data, and the extracted data.

According to another embodiment herein, a computer system comprises databases for storing logical design data, physical design data, and computer models of different aircraft systems. The computer system further comprises a computer programmed to collect physical design data, and logical design data associated with a selected one of the aircraft systems; extract data from at least one computer model of the selected aircraft system; convert the collected logical and physical design data and the extracted data into a common data format; and perform a difference analysis of the collected logical and physical design data with the extracted data.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of a method of performing analysis and verification of an aircraft system.

FIG. 2 is an illustration of a system for performing the method of FIG. 1.

FIG. 3 is an illustration of a method of performing analysis and verification of an electrical wire system.

FIG. 4 is an illustration of a display of the analysis and verification of the electrical wire system.

FIG. 5 is an illustration of a method of performing analysis and verification of a mechanical system.

FIG. 6 is an illustration of a method of performing analysis and verification of a system installation.

FIG. 7 is an illustration of a method of performing analysis and verification of a system repair.

### DETAILED DESCRIPTION

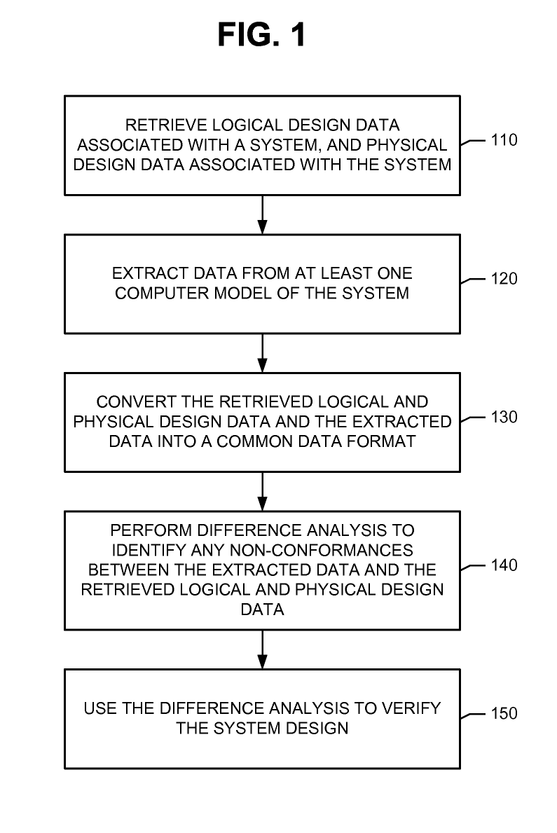

FIG. 1 illustrates a method of analyzing and verifying an aircraft system. Examples of aircraft systems include, without limitation, propulsion systems, electrical systems, hydraulic systems, environmental systems and components thereof. The analysis and verification may be performed on a system itself, or on a process associated with the system. Examples of system processes include installation of aircraft systems and repairs of aircraft systems.

The terms “logical design data ” and “computer model” and “physical design data” are used herein. Logical design data includes performance requirements for a system. A computer model is generating according to the performance requirements. The computer model may indicate function, layout, and planned location of the system. Physical design data is data about the implementation of the computer model.

At least some of the retrieved physical design data may include data that is not found in the logical design data or the computer model. As but one example, the logical design data may specify requirements for a conduit, but does not specify where in the aircraft the conduit should run (as specified by the computer model) or where the conduit actually runs (as specified by the physical design data).

In theory, the computer model satisfies all of its performance requirements, and the physical design data follows the computer model. In practice, however, this isn't always true, especially when the logical design data, computer models and physical design data are scattered among many different PDMs.

The following verification method may be performed to ensure that the logical design data, computer model, and physical design data are consistent. At block 110, logical design data associated with the system, and physical design data associated with the system are retrieved. The logical and physical design data may be retrieved from different parties who generate the data with different tools in different formats.

At block 120, data from at least one computer model of the system is extracted. For instance, the data may be extracted from several 3D computer models, some of which are generated by different computer aided design (CAD) systems.

At block 130, the retrieved logical and physical design data and the extracted data are converted into a common data format to ensure that there is a one-to-one correlation between the logical data and the physical data. For instance, the 3D geometry for the computer models is translated out of CATIA. The extractions from that 3D geometry include inferences about the geometric types, make explicit design decisions, or extraction decisions based on physical characteristics that are cast within the logical design data.

At block 140, a difference analysis is performed to identify any non-conformances between the logical design data, the computer model(s) and the physical design data. The difference analysis includes examining the one-to-one correlation between the logical design data to the physical design data and also the logical design data to the extracted data from the computer model. For instance, a first part and a second part in the logical design data will have a corresponding first part and second part in the physical design data. Physical data may be linked to logical data, for instance, via part numbers and revisions of the logical design data. There are also explicit correlations with the computer models, which link the physical design data and logical design data to the computer models.

At block 150, the difference analysis is used to verify the system design. For instance, the design may be verified by displaying any non-conformances. The non-conformances may be displayed on a computer screen, in a print out, etc.

The method of FIG. 1 ensures consistency between different requirements and designs that are managed in different tools from different PDMs. Each one of these PDM utilized tools may have a different data model. The data may be stored differently in each of the tools. The data representations may be authored in unique tools. The method brings those different data representations that were authored uniquely, often in a proprietary system, together to show what those relationships are.

The method also verifies whether a certain system is consistent with the elements that interface with the system. That is, it verifies whether a particular system can function in its layout and location. It verifies whether the correct signals flow through wires, whether the correct linkages are attached to mechanical parts, whether any parts are missing, whether a repaired system can still work properly given its location within an aircraft, etc. Inconsistencies are displayed.

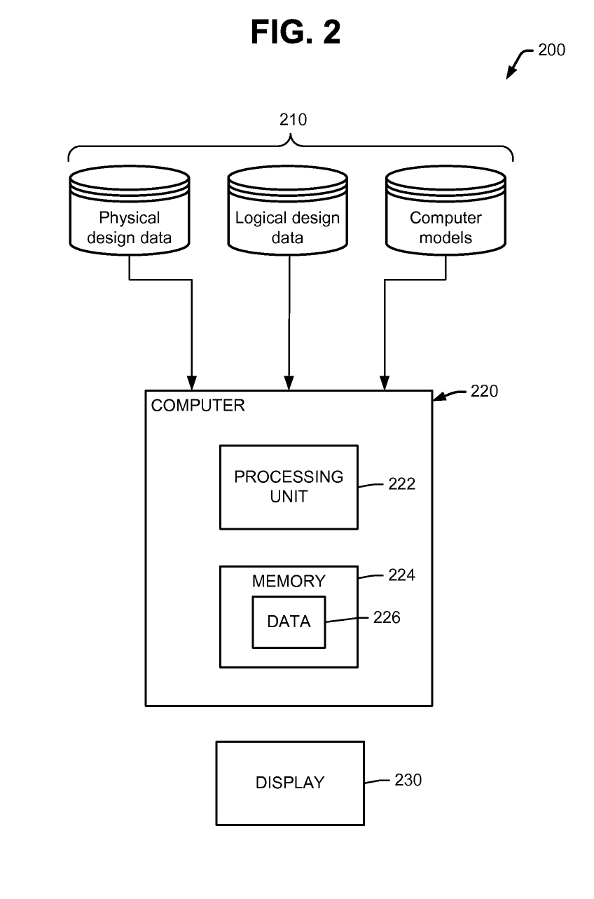

FIG. 2 is an illustration of a computer system 200 for performing the method of FIG. 1. The computer system 200 includes databases 210 for storing logical design data, physical design data, and computer models of different aircraft systems. The computer system 200 also includes a computer 220 having a processing unit 222, and memory 224 encoded with data 226. When executed, the data 226 causes the processing unit 222 to perform the method of FIG. 1. The computer system 200 may further include a display 230 (e.g., a monitor, a printer) for displaying the difference analysis.

The following paragraphs provide four examples of using the method and computer system for analysis and verification of aircraft systems. The first example involves an electrical wire system. The second example involves a mechanical system. The third example involves a method of installing a system. The fourth example involves a method of repairing a system.

### Example 1

### Electrical Wire System

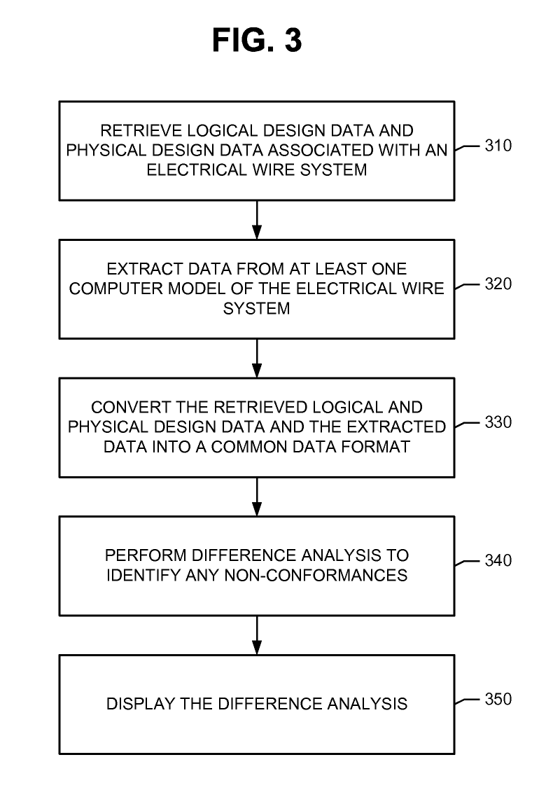

Reference is made to FIG. 3. At block 310, logical design data associated with the electrical wire system, and physical design data associated with the electrical wire system are retrieved. The logical data may be accessed from a database of wiring diagrams and schematics of the wire system. The physical data is accessed from a database of manufacturing information, maintenance wiring information, and systems information. The physical data may also include design documentation.

At block 320, data from computer models of the electrical wire system is extracted. For example, the computer models may include a computer model of a wire harness.

At block 330, the retrieved logical and physical design data and the extracted data are converted into a common data format. For example, the physical and logical design data both call out a hardware part number independently of each other. This part number is then used to link the physical and logical design data together in the common data format.

At block 340, a difference analysis is performed to identify any non-conformances between the logical design data, the computer model(s) and the physical design data. The difference analysis determines whether the electrical wire system can function in its layout and location. The difference analysis determines whether the correct signals flow through wires.

At block 350, the difference analysis is displayed. The display can visualize systems signal routing, wire segment routing, and highlight ay inconsistencies in the electrical wire system. The analysis of the entire system may be displayed, or only one or more components of the system (e.g., a wire harness assembly) may be displayed.

The display is not limited to non-conformities. Linked logical and physical data may be displayed together. Computer models may also be displayed.

Consider the example of an electrical wire system including a wire harness assembly. The method can visualize systems signal routing, wire segment routing, and highlighting a wire harness assembly within one or many wire harness installations. The method traces each individual wire to ensure that the wire harness routing is complete. The method then verifies the contents of the physical design, that is, verifies physical placement of the individual wires of the wiring harness assembly to ensure that any physical separation requirements between individual wires are met as well as to verify that the physical confines of the area the wires are to be placed provide the “real estate” needed to place that portion of the wiring harness assembly. With reference to physical separation requirements, certain signals may need to be redundant, and therefore routed on both the left and right side of an airplane.

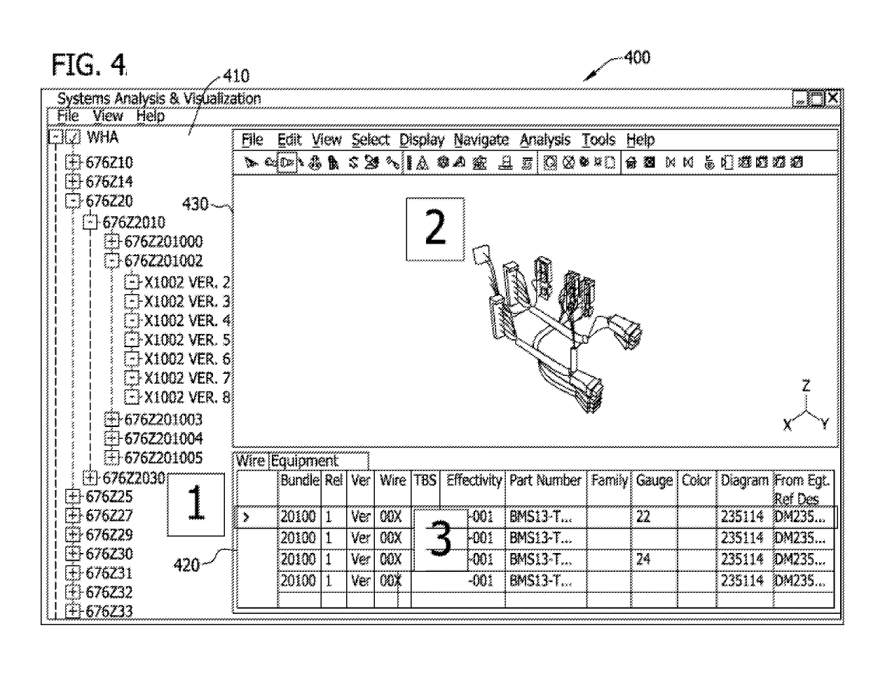

Reference is made to FIG. 4, which illustrates a display 400 of a wire harness assembly. The display 400 integrates wire bundle information 410, detail wire information 420, with a computer model 430 of the wire harness assembly. Though not shown in FIG. 4, the display 400 may include features such as coloration or “highlighting” of missing design information and spatial requirement violations. Routing and clearance provisions may also be verified.

Detail wire information 420 is a detail view of the wiring bundle components and system connection characteristics. The wiring bundle component detail including wires, connections, and other bundle components for a selected bundle are provided. Detail wire information 420 also includes detailed information about the connective equipment interfaces.

The display 400 may include physical design data of the requested wire harnesses and installations. The display 400 may also provide logical design data such as engineering specifications and engineering drawings.

### Example 2

### Mechanical System

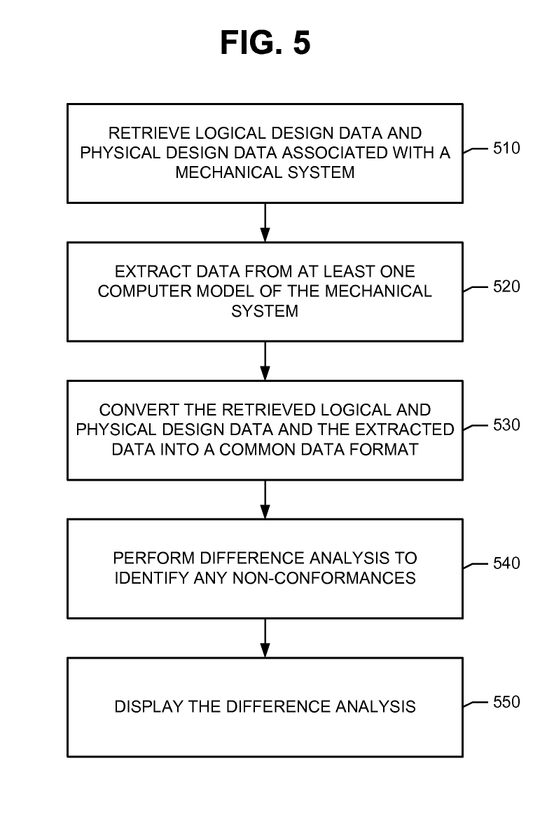

Reference is made to FIG. 5. At block 510, logical design data associated with the mechanical system, and physical design data associated with the mechanical system are retrieved. The logical design data may include mechanical diagrams and system schematics.

The physical design data may include layout and location of the components of the mechanical system. This data may be derived from physics of the system. Consider the example of a hydraulic system that includes pumps, valves, reservoirs, and transport elements (e.g., tubes, hoses and ducts). In this example, physics may be used to determine for fluid flow, tube characteristics (e.g., tube diameter), characteristics of fittings, ram characteristic, reservoir capacity, etc. The physical design data also includes elements that interface with each component in the mechanical system. For instance, the physical design data may also include interface control documentation.

At block 520, data from computer models of the mechanical system is extracted. The computer models may identify layout and location of various components such as pumps, tubes, and electrical wires.

At block 530, the retrieved logical and physical design data and the extracted data are converted into a common data format. At block 540, a difference analysis is performed to identify any non-conformances between the logical design data, the computer model(s) and the physical design data. The difference analysis determines whether each component in the mechanical system can function in its layout and location. This may involve analysis of fluid flow, mechanical interfaces, etc.

At block 550, the difference analysis is displayed. Non-conformances may be displayed. Computer models may be displayed. Linked data in the mechanical systems logical and physical data may be combined to visualize the mechanical system. As but one example, each hydraulic circuit in the system may be traced.

The method provides the capability to verify and validate mechanical system designs prior to production release. The method ensures that the logical design data that is authored in one PDM is consistent with the computer model created by another PDM.

### Example 3

### System Installation

The method of FIG. 1 may be adapted for system installation. The method may be used to identify systems that have been installed in an aircraft, and it may be used to identify systems that need to be installed.

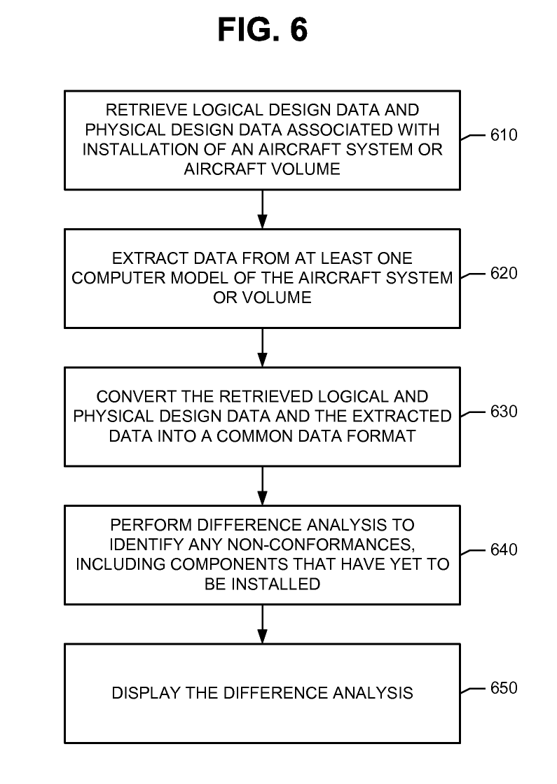

Reference is made to FIG. 6. At block 610, logical design data associated with the system installation, and physical design data associated with the system installation are retrieved. The logical design data may include installation instructions (e.g., assembly instructions) and parts lists of the system being installed. The logical design data may also be obtained by reverse engineering the buildup of the system. The physical design data may be provided by installation records.

At block 620, data from physical design data is extracted. The computer models may include engineering analysis and design definitions is scattered across multiple PDMs.

At block 630, the retrieved logical and physical design data and the extracted data are converted into a common data format. For instance, each specification calls out a specification number of an installation. A specification number may be used as an index to the link the physical and logic design data.

At block 640, analysis is performed to reveal any non-conformances between the logical design data, physical design data, and extracted data. In this example, the non-conformances include components that have yet to be installed.

The non-conformances may also include differences in installation instructions and models of the system. The non-conformances may also include differences in installation records and models of the system.

At block 650, the difference analysis is displayed. The display may reveal missing components and other non-conformances. The display may also provide status of system installation (e.g., percent completed).

Linked data in installation logical and physical data may be combined to visualize previous installations, as built part installations, 3D geometry, pre and post step installation analysis, part configuration, and engineering authority for single, zoned, and integrated assemblies.

For a large, complex system such as a commercial jetliner, the logical and physical design data, as well as the computer models, may be organized according to “volumes.” Volumes refer to 3D volumes or sections of the aircraft. A volume may contain more than one system. In some instances, the method may be used to analyze a section of the aircraft rather than a particular system in the aircraft or a particular component of a system.

With respect to a system having the size and complexity of a commercial jetliner, the display can reveal the following build issues:
a) Given a section or “volume” of the aircraft, the display identifies the work to be done in order for the section to be completed.
b) If a missing section in an assembly (e.g., a portion of an air duct) is identified in the given volume, the display can identify a missing part by part number and link to the installation instructions that installs the part. For example, the part number may be identified from the computer models, and the installation instructions can be identified. Tooling lists may also be identified.
c) If a missing part is specified, the display can identify the location where the part should be installed. The display can also show the parts that have been installed.

### Example 4

### System Repair

The method of FIG. 1 may be adapted for structural repair. As used herein, a structural refers to the replacement of a structure in the system (e.g., a damaged structure). The structural repair may involve new parts that are needed to remove the structure, it may involve a replacement structure, it may involve parts needed to interface the replacement structure with existing structure (that is, structure not being repaired), and it may involve repair procedures. For instance, if a load-bearing structure is damaged, the structural repair may involve a replacement structure, doublers for fastening the replacement structure to existing structure, and repair procedures for making the repair. A structural repair is not limited to replacing load-bearing members. For instance, a structural repair may include replacing a component of an electrical system.

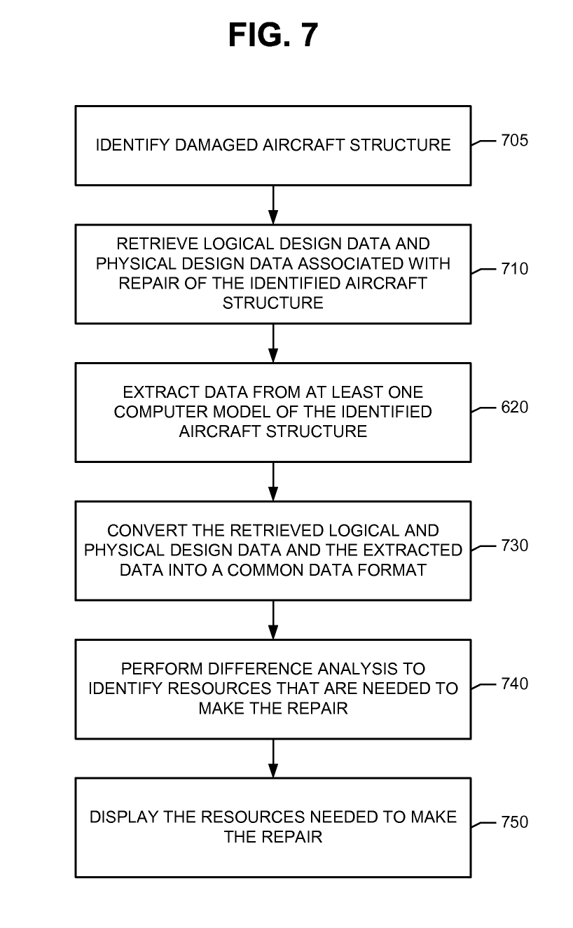

Reference is made to FIG. 7, which illustrates a method for identifying resources needed to carry out a structural repair of an aircraft system. At block 705, a damaged aircraft structure is identified. For instance, a specific system or a volume of the aircraft is selected, where the selected volume contains the damaged structure. The volume may be selected, for example, by selecting a maintenance zone, or a part or assembly number. The volume may instead be selected via a finite element model grid reference.

At block 710, logical design data associated with the structural repair is accessed. The logical design data may include design manual reference sections, external and internal load information, original structural analysis and check documentation, and repair manual references. The logical design data may also include margin of safety information regarding the parts (e.g., how the parts fail and their load cases).

Also at block 710, physical design data associated with the structural repair is accessed. Physical design data may include data associated with the previous structural repairs in the selected volume. The physical design data may identify structures that have to be replaced or repaired, fasteners that are needed to install a replacement or repaired part, repair procedures, etc. This data may also include, for previous structural repairs, as built engineering loads, 3D geometry, stress analysis, finite element analysis, internal loading, part configuration, and engineering authority.

At block 720, data from computer models are extracted. The computer models include models of the replacement structure, computer models of new parts, and models of the existing system. These models reveal how the replacement structure and the new parts interface with the existing system.

At block 730, the retrieved logical and physical design data and the extracted data are converted into a common data format. For example, the physical and logical design data are linked through a part number of the replacement part.

At block 740, a difference analysis is performed. The difference analysis indicates whether the replacement structure and new parts are compatible with the existing system. The difference analysis may reveal any non-conformances between the logical design data, physical design data, and extracted data. In this example, the difference analysis may identify non-conformances between the existing system and the replacement structure/new parts.

At block 750, the difference analysis is displayed. The display includes the non-conformances. The display may also include computer models of the replacement structure, existing structure, and new parts needed.

The display may also identify resources that are needed to make the repair. The resources may include physical design data associated with the repair, and logical design data associated with the repair. The resources may also include tools for performing structural analysis on a repaired structure.

The display may also reveal multiple repair procedures that are needed to install a replacement structure. The display may indicate whether procedures can be replaced if the repair is not proceeding as planned. It may provide a list of procedures and determine which procedure or procedures are relevant.

The method is especially useful for the repair of composite aircraft structures. The flow time for researching structural data is greatly reduced, as the method provides rapid access to design analysis data and repair stress analysis before the repair can be certified and the aircraft returned to service.

The method can reduce unscheduled down-time required for repair of incident damage, in which a high degree of automation and data integration is needed to support repair design and analysis for AOG (Aircraft On Ground) structural damage events. Reducing the down time reduces the loss of revenue while the airplane is waiting for repair.

1. A verification method for an aircraft system, the method comprising:
retrieving logical design data associated with the system, and physical design data associated with the system;
extracting data from a computer model of the system;
converting the retrieved logical and physical design data and the extracted data into a common data format; and
performing a difference analysis of the logical and physical design data with the extracted data from the model to identify any non-conformances between the logical design data, the computer model and the physical design data.

2. The method of claim 1, further comprising displaying any non-conformances.

3. The method of claim 2, further comprising displaying linked logical and physical data.

4. The method of claim 3, further comprising displaying the computer model.

5. The method of claim 1, wherein the computer model is a 3D model generated from the logical data, and wherein at least some of the extracted data includes data that is not found in the logical design data.

6. The method of claim 1 wherein the computer model includes function, layout, and planned location of the system.

7. The method of claim 1, wherein the difference analysis includes examining a one-to-one correlation between the logical design data to the physical design data and also the logical design data to the extracted data.

8. The method of claim 7, wherein the non-conformances include at least one of missing design information and spatial requirement violations.

9. The method of claim 1, wherein the system is an electrical wire system, wherein the logical design data includes schematics and wiring diagrams of the system, and the physical design data includes layout and location of wires in the wire system.

10. The method of claim 9, wherein performing the difference analysis includes tracing each individual wire in the system to ensure that wire routing is complete.

11. The method of claim 1, wherein the system is a mechanical system, wherein the logical design data includes specifications of the mechanical system, and the physical design data includes layout and location of the mechanical system.

12. The method of claim 11, wherein performing the difference analysis includes tracing each hydraulic circuit in the system.

13. The method of claim 1, further comprising selecting a volume of an aircraft for installation of the system, wherein the logical design data includes engineering drawings of the system, wherein the physical design data includes installation records associated with the system, and wherein the difference analysis reveals any structures that have yet to be installed in the aircraft.

14. The method of claim 13, wherein performing the difference analysis includes determining status of completion of installing the system in the aircraft.

15. The method of claim 1, further comprising selecting a volume of an aircraft for structural repair; wherein the physical design data includes data associated with previous structural repairs within the selected volume, and wherein the difference analysis reveals resources that are needed for the repair.

16. The method of claim 15, wherein the structural repair involves a replacement structure, and new parts needed to interface the replacement structure with existing structure of the aircraft, and wherein non-conformances between the replacement structure, the new parts, and existing structure are identified and displayed.

17. The method of claim 16, wherein design data and computer models associated with the replacement structure, the new parts, and the existing structure are also displayed.

18. The method of claim 17, wherein repair procedures associated with the structural repair are also displayed.

19. An article comprising non-transitory memory encoded with data for causing a processor to:
access physical design data, and logical design data associated with an aircraft system;
extract data from at least one computer model of the aircraft system;
convert the retrieved logical and physical design data and the extracted data into a common data format; and
perform a difference analysis to identify any non-conformances between the retrieved logical design data, the retrieved physical design data, and the extracted data.

20. A computer system comprising:
databases for storing logical design data, physical design data, and computer models of different aircraft systems; and
a computer programmed to collect physical design data, and logical design data associated with a selected one of the aircraft systems;
extract data from at least one computer model of the selected aircraft system;
convert the collected logical and physical design data and the extracted data into a common data format; and
perform a difference analysis of the collected logical and physical design data with the extracted data.
